(19) United States
(12) Patent Application Publication
(10) Pub. No.: US 2026/0170422 A1
(43) Pub. Date: Jun. 18, 2026

(54) Information Processing Device, Information Processing Method, and a Non-Transitory Recording Medium

(71) Applicant: Softbank Group Corp., Tokyo (JP)

(72) Inventor: Tatsuro Kambe, Tokyo (JP)

(21) Appl. No.: 19/420,999

(22) Filed: Dec. 16, 2025

(30) Foreign Application Priority Data
Dec. 17, 2024 (JP) 2024-220717

(51) Int. Cl. G06Q 10/047; G01C 21/36; G06Q 50/43

(52) U.S. Cl. CPC G06Q 10/047; G01C 21/3691; G06Q 50/43

(57) ABSTRACT

Provided is an information processing device including a memory and a processor connected to the memory, in which the processor is configured to: acquire an instruction from a driver transmitted from a terminal and acquire real-time information from an external database; perform identification processing of acquiring an analysis result for optimizing an operation of the driver from a data generation model based on the instruction and the acquired real-time information; and output information related to the operation of the driver to the terminal based on the analysis result.

### CROSS-REFERENCE TO RELATED APPLICATION

This application is based on and claims priority under 35 USC 119 from Japanese Patent Application No. 2024-220717 filed on Dec. 17, 2024, the disclosure of which is incorporated by reference herein.

### BACKGROUND

### Technical Field

The present disclosure relates to an information processing device, an information processing method, and an information processing program.

### Related Art

Japanese Patent Application Laid-Open (JP-A) No. 2022-180282 discloses a persona chatbot control method executed by at least one processor, the method including: receiving a user utterance; adding the user utterance to a prompt including an instruction associated with a description regarding a character of a chatbot; encoding the prompt; and inputting the encoded prompt into a language model to generate a chatbot utterance that is responsive to the user utterance.

### SUMMARY OF THE INVENTION

In the taxi industry and the ride-sharing industry, whether or not a driver can efficiently acquire passengers determines the success or failure of business. However, there is a problem that it is difficult for an inexperienced driver or a driver who is unfamiliar with the local geography to perform efficient operation due to lack of experience or local knowledge. In addition, these problems have become more apparent due to the lifting of the ban on ride-sharing and the increase in the number of foreign drivers. Furthermore, even when fully automatic driving is considered, development of a system that supports efficient and safe operation is required. Therefore, a means for solving these problems is required.

The disclosure has been made in view of the above points, and an object of the present disclosure is to provide an information processing device, an information processing method, and a non-transitory recording medium storing an information processing program that enable a driver to efficiently acquire passengers.

An information processing device according to a first aspect of the disclosure includes: a memory; and a processor connected to the memory, in which the processor is configured to: acquire an instruction from a driver transmitted from a terminal and acquire real-time information from an external database; perform identification processing of acquiring an analysis result for optimizing an operation of the driver from a data generation model based on the instruction and the acquired real-time information; and output information related to the operation of the driver to the terminal based on the analysis result.

An information processing device according to a second aspect of the disclosure is the information processing device according to the first aspect, in which the processor is configured to acquire event information, weather information, and traffic information as the real-time information.

An information processing device according to a third aspect of the disclosure is the information processing device according to the second aspect, in which the processor is further configured to acquire payment information in a restaurant from the external database.

An information processing device according to a fourth aspect of the disclosure is the information processing device according to any one of the first to third aspects, in which the processor is further configured to acquire unstructured information from the external database.

An information processing device according to a fifth aspect of the disclosure is the information processing device according to the fourth aspect, in which the processor is further configured to acquire information posted on a social network service as the unstructured information from the external database.

An information processing device according to a sixth aspect of the disclosure is the information processing device according to any one of the first to fifth aspects, in which the processor is configured to analyze an emotional state of the driver and optimize the operation of the driver based on the emotional state of the driver.

An information processing device according to a seventh aspect of the disclosure is the information processing device according to the sixth aspect, in which the processor is configured to optimize the operation of the driver by adjusting a route based on the emotional state of the driver.

An information processing method according to an eighth aspect of the disclosure is a method for causing a processor to execute processing of: acquiring an instruction from a driver transmitted from a terminal and acquiring real-time information from an external database; performing identification processing of acquiring an analysis result for optimizing an operation of the driver from a data generation model based on the instruction and the real-time information; and outputting information related to the operation of the driver to the terminal based on the analysis result.

A non-transitory recording medium according to a ninth aspect of the disclosure stores an information processing program for causing a computer to execute processing of: acquiring an instruction from a driver transmitted from a terminal and acquiring real-time information from an external database; performing identification processing of acquiring an analysis result for optimizing an operation of the driver from a data generation model based on the instruction and the real-time information; and outputting information related to the operation of the driver to the terminal based on the analysis result.

According to the disclosure, it is possible to provide an information processing device, an information processing method, and a non-transitory recording medium storing an information processing program that enable a driver to efficiently acquire a passenger.

### BRIEF DESCRIPTION OF THE DRAWINGS

Exemplary embodiments of the present disclosure will be described in detail based on the following figures, wherein:

FIG. 1 is a diagram illustrating an example of a configuration of a data processing system 10 according to an embodiment of the disclosed technology;

FIG. 2 is a diagram illustrating an example of main functions of a data processing device and a smart device;

FIG. 3 is a diagram illustrating a functional configuration example of an identification processing unit;

FIG. 4 is a diagram illustrating an example of a screen output to a display by a smart device;

FIG. 5 is a diagram illustrating an example of a flow of identification processing executed by the data processing device;

FIG. 6 is a diagram illustrating an emotion map on which a plurality of emotions are mapped; and

FIG. 7 is a diagram illustrating an emotion map on which a plurality of emotions are mapped.

### DETAILED DESCRIPTION OF THE INVENTION

Hereinafter, an example of an embodiment of the disclosure will be described with reference to the drawings. In the drawings, the same or equivalent components and portions are denoted by the same reference numerals. In addition, dimensional ratios in the drawings are exaggerated for convenience of description, and may be different from actual ratios.

Hereinafter, an example of an embodiment of a system according to the technology of the disclosure will be described with reference to the accompanying drawings.

First, words used in the following description will be described.

In the following embodiments, a processor (hereinafter, simply referred to as a “processor”) denoted by reference numeral may be one arithmetic device or a combination of a plurality of arithmetic devices. In addition, the processor may be one type of arithmetic device or a combination of a plurality of types of arithmetic devices. Examples of the arithmetic device include a central processing unit (CPU), a graphics processing unit (GPU), a general-purpose computing on graphics processing units (GPGPU), an accelerated processing unit (APU), and the like.

In the following embodiments, a random access memory (RAM) denoted by reference numeral is a memory in which information is temporarily stored, and is used as a work memory by a processor.

In the following embodiments, a storage denoted by reference numeral is one or more nonvolatile storage devices that store various programs, various parameters, and the like. Examples of the nonvolatile storage device include a flash memory (solid state drive (SSD)), a magnetic disk (for example, a hard disk), and a magnetic tape.

In the following embodiments, a communication interface (I/F) denoted by reference numeral is an interface including a communication processor, an antenna, and the like. The communication I/F manages communication between a plurality of computers. Examples of the communication standard applied to the communication I/F include wireless communication standards including 5th generation mobile communication system (5G), Wi-Fi (registered trademark), Bluetooth (registered trademark), and the like.

In the following embodiments, “A and/or B” is synonymous with “at least one of A and B”. That is, “A and/or B” means only A, only B, or a combination of A and B. Furthermore, in the present specification, the same concept as “A and/or B” is applied also in a case where three or more matters are combined and expressed by “and/or”.

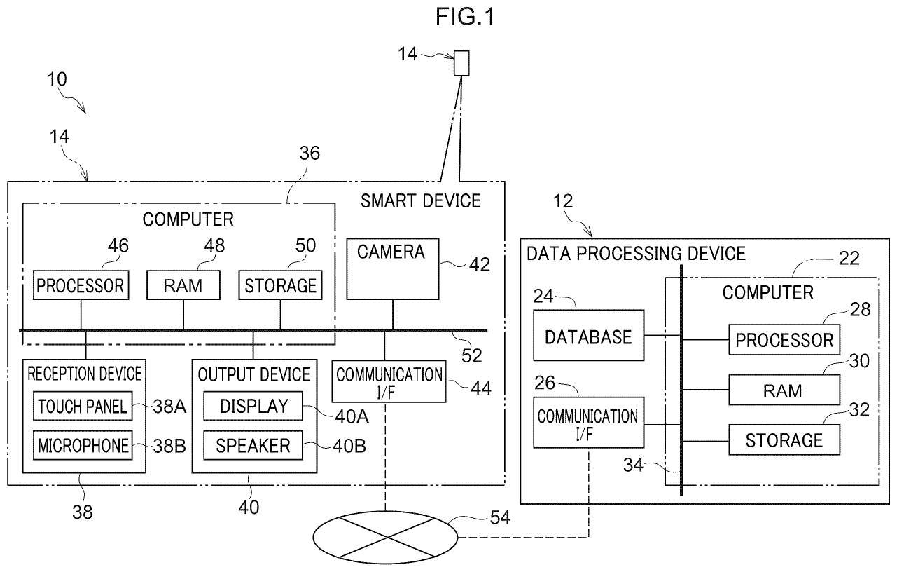

FIG. 1 illustrates an example of a configuration of a data processing system 10 according to an embodiment of the disclosure.

As illustrated in FIG. 1, the data processing system 10 includes a data processing device 12 and a smart device 14. An example of the data processing device 12 is a server.

The data processing device 12 includes a computer 22, a database 24, and a communication I/F 26. The computer 22 is an example of a “computer” according to the technology of the disclosure. The computer 22 includes a processor 28, a RAM 30, and a storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a wide area network (WAN) and/or a local area network (LAN).

The smart device 14 includes a computer 36, a reception device 38, an output device 40, a camera 42, and a communication I/F 44. The computer 36 includes a processor 46, a RAM 48, and a storage 50. The processor 46, the RAM 48, and the storage 50 are connected to a bus 52. The reception device 38, the output device 40, and the camera 42 are also connected to the bus 52.

The reception device 38 includes a touch panel 38A, a microphone 38B, and the like, and receives a user input. The touch panel 38A detects contact of an indicator (for example, a pen, a finger, or the like) to receive a user input by the contact of the indicator. The microphone 38B receives a user input by voice by detecting the voice of the user. A control unit 46A transmits data indicating the user input received by the touch panel 38A and the microphone 38B to the data processing device 12. In the data processing device 12, the identification processing unit 290 acquires data indicating a user input.

The output device 40 includes a display 40A, a speaker 40B, and the like, and presents data to a user 20 by outputting the data in an expression (for example, voice and/or text) perceptible by the user 20. The display 40A displays visible information such as text and images in accordance with an instruction from the processor 46. The speaker 40B outputs a voice in accordance with an instruction from the processor 46. The camera 42 is a small digital camera on which an optical system such as a lens, a diaphragm, and a shutter and an imaging element such as a complementary metal-oxide-semiconductor (CMOS) image sensor or a charge coupled device (CCD) image sensor are mounted.

The communication I/F 44 is connected to the network 54. The communication I/Fs 44 and 26 manage exchange of various types of information between the processor 46 and the processor 28 via the network 54.

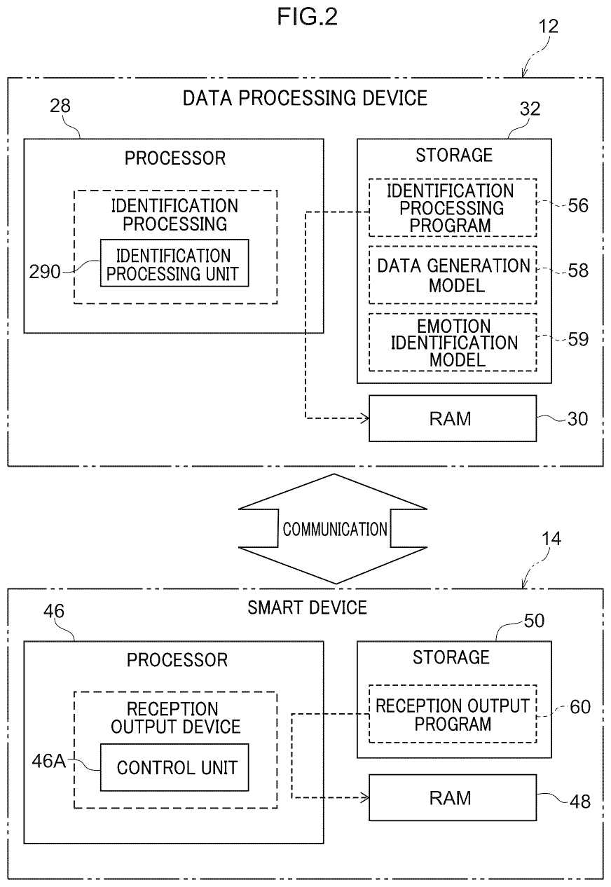

FIG. 2 illustrates an example of main functions of the data processing device 12 and the smart device 14.

As illustrated in FIG. 2, in the data processing device 12, identification processing is performed by the processor 28. The storage 32 stores an identification processing program 56. The identification processing program 56 is an example of an “information processing program” according to the technology of the disclosure. The processor 28 reads the identification processing program 56 from the storage 32 and executes the read identification processing program 56 on the RAM 30. The identification processing is realized by the processor 28 operating as the identification processing unit 290 according to the identification processing program 56 executed on the RAM 30.

The storage 32 stores a data generation model 58 and an emotion identification model 59. The data generation model 58 and the emotion identification model 59 are used by the identification processing unit 290.

The data generation model 58 is a so-called generative artificial intelligence (AI). Examples of the data generation model 58 include a generative AI such as ChatGPT (registered trademark) (Internet search <URL: https://openai.com/blog/chatgpt>) and Gemini (registered trademark) (Internet search <URL: https://gemini.google.com/?hl=ja>). The data generation model 58 is obtained by causing the neural network to perform deep learning. To the data generation model 58, a prompt including an instruction is input, and inference data such as voice data indicating voice, text data indicating text, and image data indicating an image is input. The data generation model 58 infers the input inference data according to the instruction indicated by the prompt, and outputs the inference result in a data format such as voice data and text data. Here, the inference refers to, for example, analysis, classification, prediction, and/or summary.

In the smart device 14, reception output processing is performed by the processor 46. The storage 50 stores a reception output program 60. The reception output program 60 is used in combination with the identification processing program 56 by the data processing system 10. The processor 46 reads the reception output program 60 from the storage 50 and executes the read reception output program 60 on the RAM 48. The reception output process is realized by the processor 46 operating as the control unit 46A according to the reception output program 60 executed on the RAM 48.

In the present embodiment, the smart device 14 is provided in a vehicle such as a taxi or a ride-sharing vehicle that performs business of carrying passengers to a destination.

Next, identification processing by the identification processing unit 290 of the data processing device 12 will be described. In the following description, the data processing device 12 is also referred to as a “server”, and the smart device 14 is also referred to as a “terminal”.

In the embodiment, the identification processing unit 290 executes, as the identification processing, processing of determining a place to which the vehicle should head in order to pick up passengers, and transmitting information of the determined place to the smart device 14.

First, the driver of the vehicle inputs, to the smart device 14, an instruction to inquire about a place to be headed to for picking up a passenger. The instruction at this time may be input by characters or may be input by voice so that the driver can give an instruction even while driving. In response to an inquiry from the driver, the smart device 14 inquires of the data processing device 12 about a place to be headed to for picking up a passenger. The data processing device 12 analyzes real-time information such as event information, weather information, traffic information, and payment information, and formulates information regarding the operation of the driver, for example, a place to be headed to for picking up a passenger, on the basis of the analysis result. The data processing device 12 transmits, to the smart device 14, information on a place to be headed to for picking up the passenger.

The smart device 14 receives the information transmitted from the data processing device 12 and presents the received information to the driver. In particular, the smart device 14 transmits information received through voice synthesis technology to the driver by voice in addition to information by characters or instead of information by characters. Since information is transmitted by voice, the driver can obtain information without using a hand. By obtaining information without using a hand, the driver can acquire necessary information without diverting attention during driving, and can continue driving safely. The driver can greatly improve his/her own operation efficiency by using this system. For example, even when operation in an area where experience or local knowledge is usually required, it is possible to efficiently acquire passengers even in an area visited for the first time on the basis of the data provided from the data processing device 12. Even when the driver needs to change the operation area in consideration of the event information of the area, a sudden change in the weather, or the like during driving, it is possible to immediately obtain the latest optimal strategy from the data processing device 12 by inputting a voice instruction to the smart device 14.

The “driver” is a person who plays a role of driving a vehicle and safely and efficiently transporting articles and persons to a destination.

The “external database” is a large-scale information aggregate that can be accessed from an enterprise system or the Internet, and stores various types of information. The “external database” includes real-time information such as various event information, weather information, traffic information, and payment information.

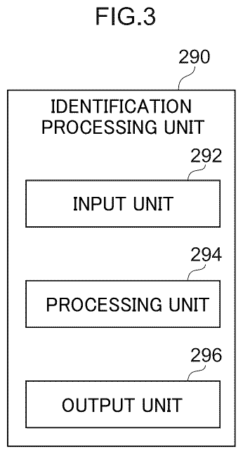

FIG. 3 is a diagram illustrating a functional configuration example of the identification processing unit 290. As illustrated in FIG. 3, the identification processing unit 290 includes an input unit 292, a processing unit 294, and an output unit 296.

An acquisition unit 292 acquires the user input received by the smart device 14. Specifically, data of at least one of a character, a voice, and an image of the user received by the smart device 14 is acquired. In the embodiment, the acquisition unit 292 acquires, as the user input received by the smart device 14, an inquiry about a place to be headed to for picking up a passenger. Specifically, the acquisition unit 292 acquires a user input “List candidates for the next target area” by the driver. In addition, the acquisition unit 292 acquires real-time information such as event information, weather information, traffic information, and payment information from the external database. In the external database, the data is periodically updated, and is configured to always maintain the latest state in real time.

The processing unit 294 performs identification processing using the data generation model 58. Specifically, data of characters, voices, and images input by the user is input to the data generation model 58, and a generation result is obtained. In the embodiment, the processing unit 294 acquires an analysis result for optimizing the operation of the driver from the data generation model 58 using the data acquired by the acquisition unit 292. Specifically, the processing unit 294 generates an instruction such as “The current position of the vehicle is near Hamamatsucho Station. Please acquire information from the external database in real time, and on the basis of the acquired information, list candidates for the next area targeted by the driver”, and the generated instruction is given to the data generation model 58. The data generation model 58 outputs an answer based on the instruction. For example, the data generation model 58 outputs, as a response based on the instruction, a response such as “The number of customers leaving a restaurant is reaching a peak around Nishi-Shimbashi 2-chome” or “The business show ends at 16:00 at Port City Takeshiba”. Note that the information on the current position of the vehicle may be obtained by a position information sensor such as a global positioning system (GPS) sensor provided in the vehicle.

The data generation model 58 may generate an answer to the instruction using unstructured information. Examples of the unstructured information include posting to a social network service, weather information, and an image in which a bus stand or a taxi stand is captured by a network camera. For example, in a case where posts such as “There is no taxi at the taxi stand at Kokusai-tenjijo Station” are increasing in the social network service at the timing when the instruction has been received, the data generation model 58 may output an answer such as “There are many people waiting for a taxi at Kokusai-tenjijo Station” as an answer based on the instruction. Furthermore, for example, in a case where posts such as “Personal injury accident has occurred on the Tokaido Line” are increasing at the timing when the instruction has been received, the data generation model 58 may output an answer such as “A personal injury accident has occurred on the Tokaido Line, so the number of people who use a taxi near Shinagawa Station is likely to increase.” as an answer based on the instruction.

Furthermore, for example, in a case where a state in which there are many people waiting for a bus at a bus stop in front of Toyosu Station has been captured by the network camera at the timing when the instruction has been received, the data generation model 58 may output an answer such as “There are many people waiting for a bus at a bus stop in front of Toyosu Station” as an answer based on the instruction. In addition, for example, at the timing when the instruction is received, if it is found that it will rain in central Tokyo 15 minutes later according to the rain cloud radar, the data generation model 58 may output an answer such as “Since it is going to rain soon, the number of people who use a taxi near Shimbashi Station is likely to increase.” as an answer based on the instruction.

Note that the data generation model 58 is not limited to a single information source, and it goes without saying that an answer may be output on the basis of a plurality of information sources.

The output unit 296 transmits the result of the identification processing to the smart device 14. In the embodiment, the output unit 296 transmits the answer acquired by the processing unit 294 from the data generation model 58 to the smart device 14. In the smart device 14, the control unit 46A causes the output device 40 to output the result of the identification processing. The microphone 38B acquires a voice indicating a user input for a result of the identification processing. Note that the control unit 46A transmits the voice data indicating the user input acquired by the microphone 38B to the data processing device 12.

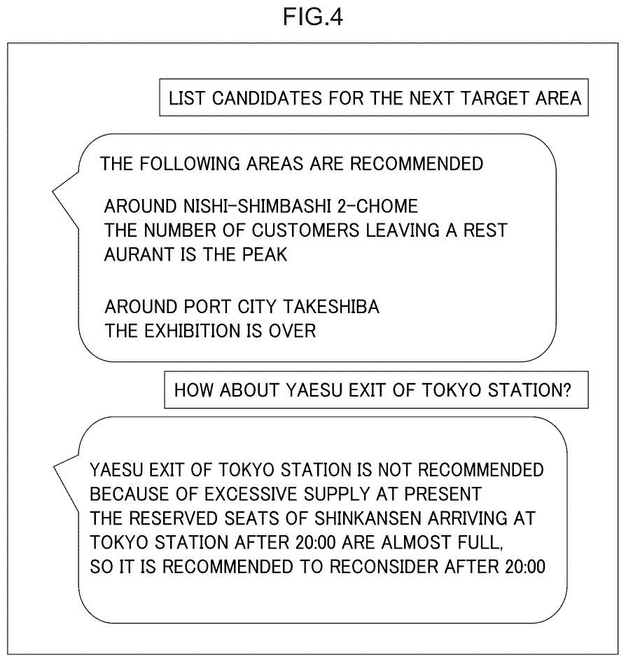

FIG. 4 is a diagram illustrating an example of a screen output from the smart device 14 to the display 40A. When the driver makes an inquiry about “Tell me candidates for the next target area” to the smart device 14 by voice, the smart device 14 converts the content of the inquiry by voice from the driver into text and displays the text on the display 40A. Then, the smart device 14 displays, on the display 40A, information on the candidate for the next target area transmitted from the data processing device 12. In the example of FIG. 4, the vicinity of Nishi-Shimbashi 2-chome and Port City Takeshiba are displayed on the display 40A as candidates for the next target area.

After the candidates of the next target area proposed by the data processing device 12 are displayed on the display 40A and before the data processing device 12 is caused to propose the candidates of the next target area, there is a case where the driver wants to confirm whether the specific area is appropriate as a candidate of the next target area. In response to an inquiry from the driver as to whether a specific area is appropriate as a candidate for the next target area, the data processing device 12 may answer whether the area is appropriate as a candidate for the next target area.

For example, when the driver makes an inquiry about “How about Yaesu Exit of Tokyo Station?” to the smart device 14, the smart device 14 transmits the received user input to the data processing device 12. In the data processing device 12, for example, the processing unit 294 generates an instruction to the data generation model 58 such as “The current position of the vehicle is near Hamamatsucho Station. Please acquire information from the external database in real time, and based on the acquired information, determine whether Yaesu Exit of Tokyo Station is an appropriate area for the driver to take next”, and gives the generated instruction to the data generation model 58. Here, if it can be grasped from the information acquired from the external database that there are already many taxis at Tokyo Station, or there are not many customers in the taxi stand, the data generation model 58 may output, for example, an answer “Yaesu Exit of Tokyo Station is not recommended because of excessive supply at present.”.

Note that it is assumed that the information that can be acquired from the external database includes the reservation status of the reserved seat of Shinkansen, and the fact that the reserved seat of Shinkansen arriving at Tokyo Station is full continues after a certain time. In such a case, the data generation model 58 may output an answer such as “Yaesu Exit of Tokyo Station is not recommended because of excessive supply at present. The reserved seats of Shinkansen arriving at Tokyo Station after 20:00 are almost full, so it is recommended to reconsider after 20:00” may be output.

In the above description, the driver is a driver of a taxi or a ride-sharing vehicle, and the data processing device 12 has proposed, as the information regarding the operation of the driver, information regarding a place to be headed to for picking up passengers. However, the disclosure is not limited to such an example. The driver may be a driver who picks up or delivers a package. In this case, the data processing device 12 may propose a route suitable for pickup or delivery as information regarding operation of the driver. For example, it is assumed that the driver makes an inquiry about “Tell me a route for effectively delivering the package” to the smart device 14. In the data processing device 12, the processing unit 294 generates an instruction to the data generation model 58 such as “The current position of the vehicle is around Meguro Station. Please acquire information from the external database in real time, and propose a route for the driver to effectively deliver the package on the basis of the acquired information”, and the generated instruction is given to the data generation model 58. Then, the data processing device 12 transmits the answer generated by the data generation model 58 to the smart device 14 as a route for effectively delivering the package.

In the embodiment described above, the example in which the identification processing is performed by the data processing device 12 has been described, but the technology of the disclosure is not limited thereto, and the identification processing may be performed by the smart device 14.

Next, the operation of the data processing system 10 will be described.

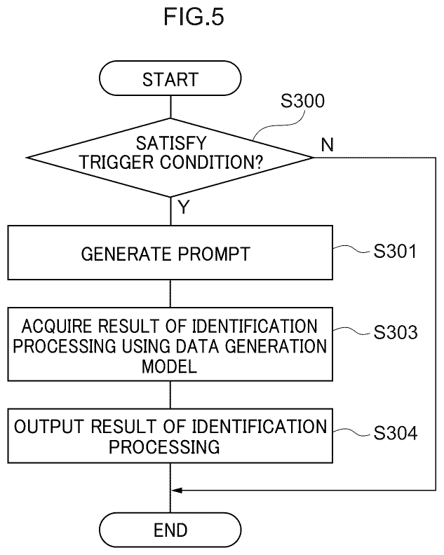

An example of a flow of identification processing executed by the data processing device 12 will be described with reference to FIG. 5. Note that the flow of the identification processing illustrated in FIG. 5 is an example of an “information processing method” according to the technology of the disclosure.

In step S300, the processing unit 294 determines whether or not a predetermined trigger condition is satisfied. The predetermined trigger condition is acquisition of the user input received by the smart device 14.

When the trigger condition is satisfied in step S300 (step S300; Yes), the data processing system 10 proceeds to step S301. On the other hand, when the trigger condition is not satisfied in step S300 (step S300; No), the data processing system 10 ends the identification processing.

In step S301, the processing unit 294 adds an instruction for obtaining a result of the identification processing by using the user input input by the smart device 14, and generates a prompt. Specifically, the processing unit 294 generates a prompt such as “The current position of the vehicle is ○○. Please acquire information from the external database in real time, and based on the acquired information, list candidates for the next area targeted by the driver.”.

In step S303, the processing unit 294 inputs the generated prompt to the data generation model 58, and acquires the result of the identification processing on the basis of the output of the data generation model 58. In the embodiment, the processing unit 294 performs processing of suggesting information on an area targeted next by the driver as identification processing.

In step S304, the output unit 296 outputs the result of the identification processing to the smart device 14, and ends the identification processing. The output unit 296 outputs information on the next target area of the driver to the smart device 14 as a result of the identification processing.

The data processing device 12 may determine a driver's emotion and suggest information on an area targeted next by the driver on the basis of the determined emotion.

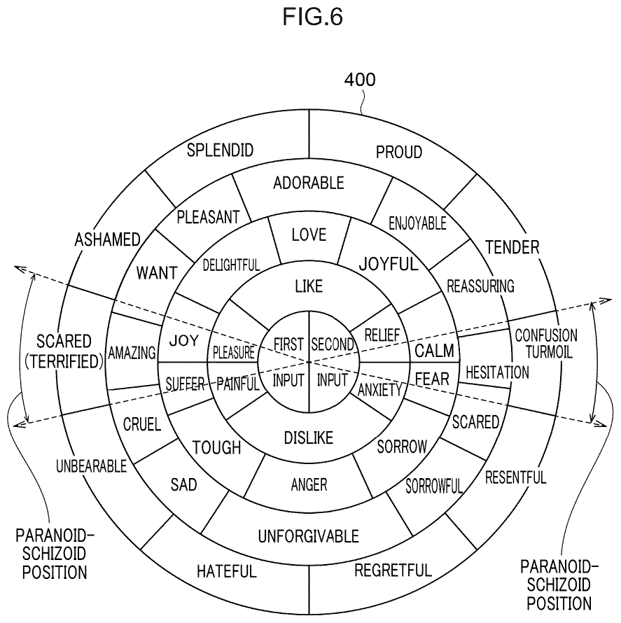

Note that the emotion identification model 59 as an emotion engine may determine the emotion of the user in accordance with a specific mapping. Specifically, the emotion identification model 59 may determine the emotion of the user on the basis of an emotion map (see FIG. 6) that is a specific mapping.

FIG. 6 is a diagram illustrating an emotion map 400 on which a plurality of emotions are mapped. In the emotion map 400, emotions are arranged concentrically radially from the center. The closer to the center of the concentric circle, the more the emotion of the primitive state is arranged. Emotions indicating states and behaviors generated from the state of mind are arranged outside the concentric circle. The emotion is a concept including an affection and a mental state. On the left side of the concentric circle, emotions generated from reactions generally occurring in the brain are arranged. On the right side of the concentric circle, emotions induced by situation determination are generally arranged. In the upward and downward directions of the concentric circles, emotions generated from reactions generally occurring in the brain and induced by situation determination are arranged. Furthermore, the emotion of “pleasant” is arranged on the upper side of the concentric circle, and the emotion of “unpleasant” is arranged on the lower side. As described above, in the emotion map 400, a plurality of emotions are mapped on the basis of a structure in which emotions are generated, and emotions that are likely to occur at the same time are mapped close to each other.

These emotions are distributed in the 3 o'clock direction of the emotion map 400, and usually come and go between relief and anxiety. In the right half of the emotion map 400, situation recognition is superior to internal sensation, and thus gives a calm impression.

Since the inside of the emotion map 400 represents the inside of the mind and the outside of the emotion map 400 represents a behavior, the emotion is more visible (appears in behavior) toward the outside of the emotion map 400.

Here, human emotion is based on various balances such as posture and blood glucose level, and indicates a state of discomfort when the balance deviates from the ideal and a state of comfort when the balance approaches the ideal. Even in a robot, an automobile, a motorcycle, or the like, on the basis of various balances such as a posture and a remaining battery level, it is possible to make an emotion so as to indicate a state of discomfort when the balance deviates from the ideal and a state of comfort when the balance approaches the ideal. The emotion map may be generated, for example, on the basis of an emotional map (Research on the phonetic recognition of feelings and a system for emotional physiological brain signal analysis, Tokushima University, PhD thesis: https://ci.nii.ac.jp/naid/500000375379) of Dr. Mitsuyoshi. In the left half of the emotional map, emotions belonging to a region called “reaction” in which sensation is superior are arranged. Furthermore, in the right half of the emotional map, emotions belonging to a region called “situation” in which situation recognition is superior are arranged.

In the emotion map, two emotions for encouraging learning are defined. One is an emotion around the middle of negative “repentance” or “reflection” on the situation side. That is, it is when a negative emotion such as “I do not want to suffer like this again” or “I do not want to be scolded” occurs in the robot. The other is a positive emotion of “desire” on the reactive side. That is, it is the time of a positive feeling such as “want more” or “want to know more”.

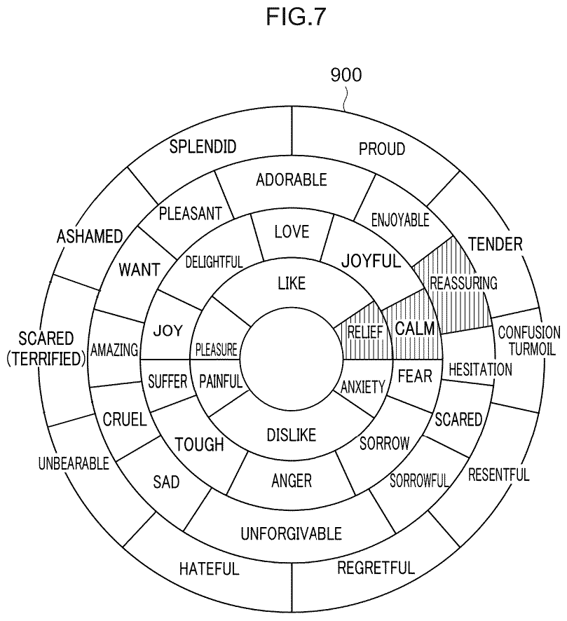

The emotion identification model 59 inputs a user input to a neural network trained in advance, acquires an emotion value indicating each emotion indicated in the emotion map 400, and determines the user's emotion. This neural network is trained in advance on the basis of a plurality of pieces of learning data that are combinations of the user input and the emotion value indicating each emotion indicated in the emotion map 400. Furthermore, in this neural network, as in an emotion map 900 illustrated in FIG. 7, emotions arranged close to each other are trained to have close values. FIG. 7 illustrates an example in which a plurality of emotions such as “relief”, “calm”, and “reassuring” have similar emotion values.

Although the system according to the disclosure is described mainly in terms of the functions of the data processing device 12, the system according to the disclosure is not necessarily implemented in a server. The system according to the disclosure may be implemented as a general information processing system. The disclosure may be implemented as, for example, a software program operating on a personal computer or an application operating on a smartphone or the like. The method according to the disclosure may be provided to a user in a software as a service (SaaS) format.

In the above embodiment, the embodiment in which the identification processing is performed by one computer 22 has been described, but the technology of the disclosure is not limited thereto, and the distributed processing for the identification processing by a plurality of computers including the computer 22 may be performed. For example, the data generation model 58 may be provided in an external device of the data processing device 12, and the external device may generate data according to input data.

In the above embodiment, the description has been given by exemplifying the embodiment in which the identification processing program 56 is stored in the storage 32, but the technology of the disclosure is not limited thereto. For example, the identification processing program 56 may be stored in a portable computer-readable non-transitory storage medium such as a universal serial bus (USB) memory. The identification processing program 56 stored in the non-transitory storage medium is installed in the computer 22 of the data processing device 12. The processor 28 executes identification processing according to the identification processing program 56.

In addition, the identification processing program 56 may be stored in a storage device such as a server connected to the data processing device 12 via the network 54, and the identification processing program 56 may be downloaded and installed in the computer 22 in response to a request from the data processing device 12.

Note that it is not necessary to store all of the identification processing program 56 in a storage device such as a server connected to the data processing device 12 via the network 54 or store all of the identification processing program 56 in the storage 32, and a part of the identification processing program 56 may be stored.

The following various processors can be used as hardware resources for executing the identification processing. Examples of the processor include a CPU which is a general-purpose processor functioning as a hardware resource that executes identification processing by executing software, that is, a program. In addition, examples of the processor include a dedicated electric circuit which is a processor having a circuit configuration exclusively designed for executing specific processing such as a field-programmable gate array (FPGA), a programmable logic device (PLD), or an application specific integrated circuit (ASIC). A memory is built in or connected to any processor, and any processor executes identification processing by using the memory.

The hardware resource that executes the identification processing may be configured by one of these various processors, or may be configured by a combination of two or more processors of the same type or different types (for example, a combination of a plurality of FPGAs or a combination of a CPU and an FPGA). The hardware resource that executes the identification processing may be one processor.

As an example of the configuration including one processor, first, there is a mode in which one processor is configured by a combination of one or more CPUs and software, and the processor functions as a hardware resource that executes identification processing. Second, as represented by a system-on-a-chip (SoC) or the like, there is a mode of using a processor that realizes a function of the entire system including a plurality of hardware resources for executing identification processing by one IC chip. In this manner, the identification processing is realized by using one or more of the above-described various processors as hardware resources.

Furthermore, more specifically, an electric circuit in which circuit elements such as semiconductor elements are combined can be used as a hardware structure of these various processors. In addition, the above-described identification processing is merely an example. Therefore, it is needless to say that unnecessary steps may be deleted, new steps may be added, or the processing order may be changed within a range not departing from the gist.

The contents described and illustrated above are detailed descriptions of parts according to the technology of the disclosure, and are merely examples of the technology of the disclosure. For example, the above description regarding the configuration, function, operation, and effect is a description regarding an example of the configuration, function, operation, and effect of the portion according to the technology of the disclosure. Therefore, it is needless to say that unnecessary portions may be deleted, new elements may be added, or replacement may be made with respect to the above described and illustrated contents without departing from the gist of the technology of the disclosure. Furthermore, in order to avoid complication and to facilitate understanding of the portion according to the technology of the disclosure, in the description content and the illustrated content described above, description regarding technical common sense or the like that does not require any particular description in enabling implementation of the technology of the disclosure is omitted.

All documents, patent applications, and technical standards described in the specification are incorporated herein by reference to the same extent as if each individual document, patent application, and technical standard were specifically and individually indicated to be incorporated by reference.

Regarding the above embodiments, the following is further disclosed.

### (Supplementary Note 1)

An information processing device including:
an acquisition unit that acquires an instruction from a driver transmitted from a terminal and acquires real-time information from an external database;
a processing unit that performs identification processing of acquiring an analysis result for optimizing an operation of the driver from a data generation model based on the instruction and the acquired real-time information; and
an output unit that outputs information related to the operation of the driver to the terminal based on the analysis result.
   (Supplementary note 2)

The information processing device according to Supplementary note 1, in which the acquisition unit acquires event information, weather information, and traffic information as the real-time information.

(Supplementary note 3)

The information processing device according to Supplementary note 2, in which the acquisition unit further acquires payment information in a restaurant from the external database.

(Supplementary note 4)

The information processing device according to Supplementary notes 1 to 3, in which the acquisition unit further acquires unstructured information from the external database.

(Supplementary note 5)

The information processing device according to Supplementary note 4, in which the acquisition unit further acquires information posted on a social network service as the unstructured information from the external database.

(Supplementary note 6)

The information processing device according to Supplementary notes 1 to 5, in which the processing unit analyzes an emotional state of the driver and optimizes the operation of the driver based on the emotional state of the driver.

(Supplementary note 7)

The information processing device according to Supplementary note 6, in which the processing unit optimizes the operation of the driver by adjusting a route based on the emotional state of the driver.

(Supplementary note 8)

An information processing method for causing a processor to execute processing of:
acquiring an instruction from a driver transmitted from a terminal and acquiring real-time information from an external database;
performing identification processing of acquiring an analysis result for optimizing an operation of the driver from a data generation model based on the instruction and the real-time information; and
outputting information related to the operation of the driver to the terminal based on the analysis result.
   (Supplementary note 9)

An information processing program for causing a computer to execute processing of:
acquiring an instruction from a driver transmitted from a terminal and acquiring real-time information from an external database;
performing identification processing of acquiring an analysis result for optimizing an operation of the driver from a data generation model based on the instruction and the real-time information; and
outputting information related to the operation of the driver to the terminal based on the analysis result.

What is claimed is:

1. An information processing device comprising:
a memory; and
a processor connected to the memory,
wherein the processor is configured to:
acquire an instruction from a driver transmitted from a terminal and acquire real-time information from an external database;
perform identification processing of acquiring an analysis result for optimizing an operation of the driver from a data generation model based on the instruction and the acquired real-time information; and
output information related to the operation of the driver to the terminal based on the analysis result.

2. The information processing device according to claim 1, wherein the processor is configured to acquire event information, weather information, and traffic information as the real-time information.

3. The information processing device according to claim 2, wherein the processor is further configured to acquire payment information in a restaurant from the external database.

4. The information processing device according to claim 1, wherein the processor is further configured to acquire unstructured information from the external database.

5. The information processing device according to claim 4, wherein the processor is further configured to acquire information posted on a social network service as the unstructured information from the external database.

6. The information processing device according to claim 1, wherein the processor is configured to analyze an emotional state of the driver and optimize the operation of the driver based on the emotional state of the driver.

7. The information processing device according to claim 6, wherein the processor is configured to optimize the operation of the driver by adjusting a route based on the emotional state of the driver.

8. An information processing method for causing a processor to execute processing of:
acquiring an instruction from a driver transmitted from a terminal and acquiring real-time information from an external database;
performing identification processing of acquiring an analysis result for optimizing an operation of the driver from a data generation model based on the instruction and the real-time information; and
outputting information related to the operation of the driver to the terminal based on the analysis result.

9. A non-transitory recording medium storing an information processing program for causing a computer to execute processing of:
acquiring an instruction from a driver transmitted from a terminal and acquiring real-time information from an external database;
performing identification processing of acquiring an analysis result for optimizing an operation of the driver from a data generation model based on the instruction and the real-time information; and
outputting information related to the operation of the driver to the terminal based on the analysis result.
